(19) United States
(12) Patent Application Publication
(10) Pub. No.: US 2024/0093511 A1
(43) Pub. Date: Mar. 21, 2024

(54) COVER DEVICE FOR GRATINGS

(71) Applicant: Sylvia Jaeger, Paderborn (DE)

(72) Inventor: Sylvia Jaeger, Paderborn (DE)

(21) Appl. No.: 18/038,681

(22) PCT Filed: Nov. 24, 2021
(86) PCT No.: PCT/DE2021/100930

§ 371 Date: May 24, 2023

(30) Foreign Application Priority Data
Nov. 24, 2020 (DE) 10 2020 131 022.6
Mar. 26, 2021 (DE) 21 165 163.3

(51) Int. Cl. E04F 15/024; E01C 9/10; E01C 17/00; E04F 15/02; E04F 15/10; E04F 19/06; F21S 4/28; G09F 13/04

(52) U.S. Cl. CPC E04F 15/02452; E01C 9/10; E01C 17/00; E04F 15/02183; E04F 15/02188; E04F 15/02405; E04F 15/02494; E04F 15/105; E04F 19/061; F21S 4/28; G09F 13/0495; E01C 2201/20; E01C 2201/207; F21Y 2103/10

(57) ABSTRACT

A cover device for gratings, having a planar support (1) and a plurality of holding elements (20) which protrude at a bottom side (7) of the support (1), wherein a plurality of elevations (10) and recesses (11) are provided on an upper side (6) of the support (1).

The invention relates to a covering device for gratings with a flat support and with a plurality of holding elements protruding from an underside of the support.

From AT233801 A a covering device for gratings is known, which consists on the one hand of a support that can be placed on an upper side of the grating and on the other hand of a plurality of holding elements protruding on a side of the support facing the grating. The support has a plurality of perforations so that liquid can drain off.

A covering device for gratings is known from DE 20 2014 106 164 U1, which has a flat support with a plurality of holding elements projecting from the underside thereof. The support does not have any perforations to allow water to drain away.

The object of the present invention is to further develop a covering device in such a way that a long-term stable support with good drainage properties for liquids is created.

To solve this problem, the invention in connection with the preamble of patent claim 1 is characterized in that a plurality of elevations and depressions are provided on an upper side of the support.

The particular advantage of the invention is that the multiple elevations and depressions arranged on the upper side form a kind of labyrinth of channels, by means of which liquid, in particular water, impinging on the covering device can be discharged. In this way, a cover can advantageously be created that is arranged in a non-slip manner and allows water to be drained off quickly and without leaving any residue.

According to a preferred embodiment of the invention, the support has a plurality of perforations, so that the drained liquid can run off downwards at several points.

According to an embodiment of the invention, the elevations and depressions are arranged distributed over the support, preferably in a chessboard-like manner, with the depressions forming channels that connect the perforations of the support to one another. In relation to a support plane, the elevations and/or the channels are designed to be inclined, so that the liquid that hits the covering device can be collected and channeled away in the direction of the perforations. In the case of the channels, it is sufficient for a channel floor to be designed to be inclined. The elevations preferably have pitched roof-like inclined surfaces, so that no liquid can collect on the upper side of the elevations. Alternatively, the elevations can also be convex or mushroom-shaped.

According to a further development of the invention, the elevations are designed so flexibly that when a force (impact) is exerted on them from above, for example by a person stepping on them, a pumping effect is generated, by means of which liquid present on the shelf can be drained, preferably to the perforations in the storage device.

According to a further development of the invention, the support has a first layer made of a rigid material and a second layer made of a flexible material. The first layer is formed as a bottom support layer, while the second layer forms a top surface of the support. The two layers are preferably connected to one another in one piece, in particular by two-component injection molding.

According to a further development of the invention, the holding elements protruding from the first layer are designed in such a way that they engage in a form-fitting manner in openings in a grating. In this way, the support is held in a detachable and secure position on the grating.

According to a further development of the invention, a connector can be provided for the positionally secure connection of a plurality of supports designed as support plates in a common plane. The connector has plug-in elements which can each be connected to adjacent support plates, preferably in a form-fitting manner. The connector is designed in such a way that the underside of the support plates can be plugged onto a respective plug-in element of the connector, so that the connectors are not visible when assembled. The connectors and the support plates are designed in such a way that, in the assembled state, they each bear on the underside on a common support plane. The ground preferably consists of a hard floor material, for example existing tiles. Advantageously, the support plates can be used more easily outdoors.

According to a preferred embodiment of the invention, the support consists of a one-piece and/or flexible material, which has the advantage of being easy to lay on a floor.

According to a development of the invention, the support has a plurality of support segments arranged in a chessboard and/or matrix-like manner, each of which has at least one perforation and at least one holding element that supports the support on the floor. The perforation is preferably arranged in the middle of the support segment, while preferably several retaining cams are arranged on the edge of the support segment. The support segments are preferably of the same design. This advantageously results in a regular structure that enables the liquid to be drained off reliably.

According to a further development of the invention, the support has a base body which extends in the support plane and from which reinforcing sections protrude on the underside. The reinforcement sections can have a contact surface for the light strip, so that the light strip is held in one plane. The contact surface of the reinforcement section runs transversely to a longitudinal extent of a light strip. In this way, the light strip rests on the base body at regular intervals along the longitudinal direction thereof.

According to a further development of the invention, the contact surface for the light strip is formed by a first connecting strut, which runs tangentially to the perforation and/or between two holding elements of the support segment. The first connecting strut preferably has a continuous contact surface for the light strip. If, in addition, a clearance between the retaining cams arranged at the end of the first connecting strut corresponds to a width of the light strip, the light strip can be held in a form-fitting and/or force-fitting manner between the two retaining cams. Preferably, the retaining cams are flexible, so that when the light strip is pushed onto the support surface from below, it is held in a form-fitting manner on the support.

According to a further development of the invention, a second connecting strut running perpendicularly to the first connecting strut is provided with a drainage groove, so that liquid draining through the perforation from an upper side of the support can drain off towards the bottom.

According to a preferred embodiment of the invention, the reinforcement section at least partially, preferably in a direction running transversely to the second connecting strut, has a greater extent than the extent of the perforation, so that even when the light strip is mounted on the support, the liquid can drain off on the bottom side.

According to a preferred embodiment of the invention, the light strip is elongated and has a rectangular or square cross section. A flat side of the light strip facing away from the perforation runs flush with a free end face of the retaining cam, so that this flat side of the light strip comes to rest on the floor and thus further stabilizes the support.

According to a development of the invention, a length of the light strip is matched to a length of the support. Ends of the light strip are electrically and mechanically connected via a connector to another light strip mounted on an adjacent shelf. In this way, any formats of the support can be combined with a light matrix formed by several light strips. Because the light sources of the light strip can be controlled individually, different graphic patterns, inscriptions or logos can be created.

Exemplary embodiments of the invention are explained in more detail below with reference to the drawings.

The drawings show:

FIG. 1 a perspective view of a covering device with a support plate with connectors mounted at the corners thereof,

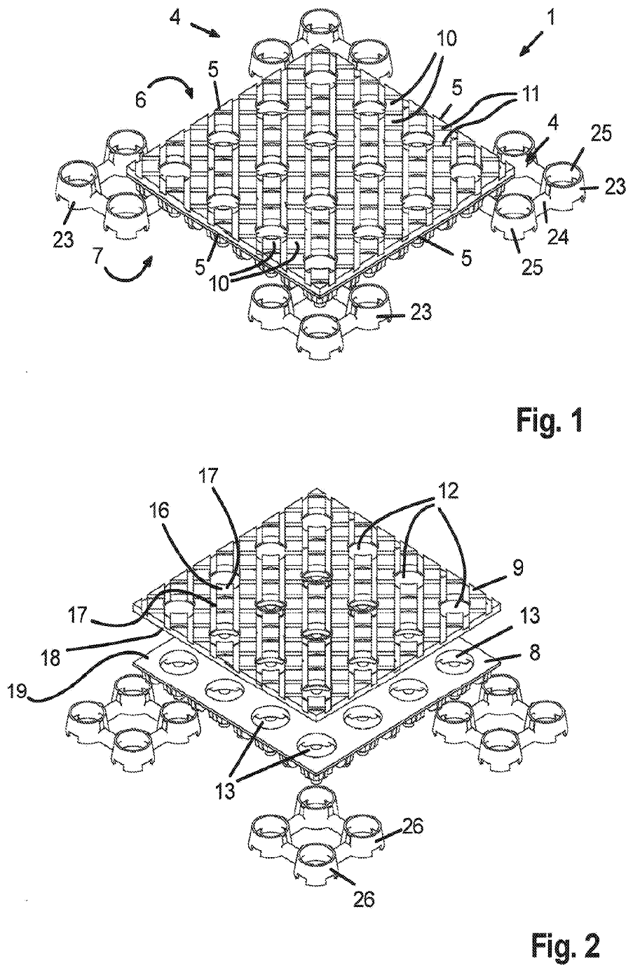

FIG. 2 an exploded view of components of the covering device,

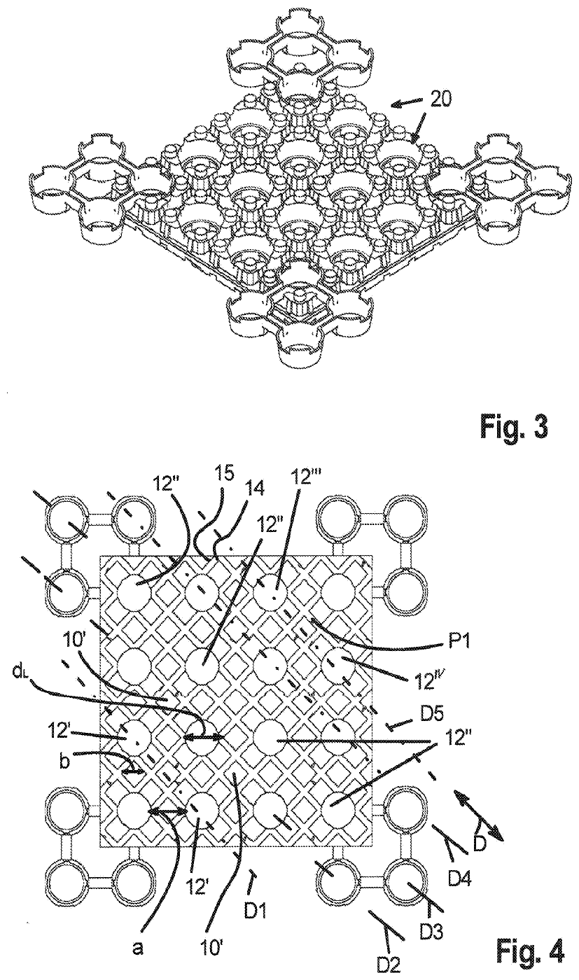

FIG. 3 a perspective view of the assembled covering device according to FIG. 1 from below,

FIG. 4 a top view of the installed covering device,

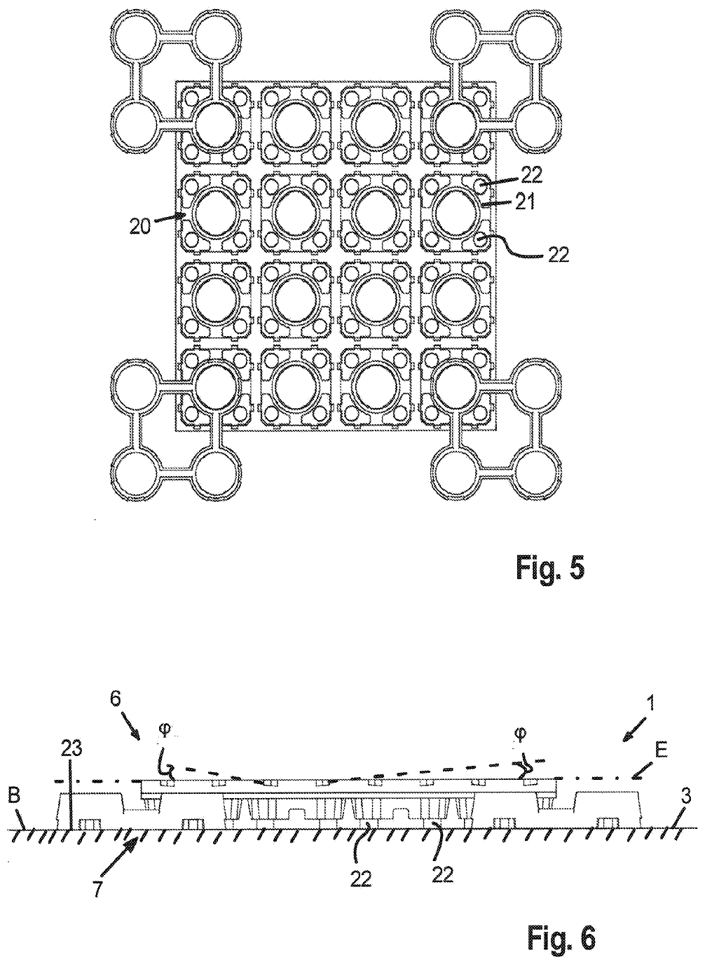

FIG. 5 a bottom view of the mounted covering device,

FIG. 6 a side view of the mounted covering device,

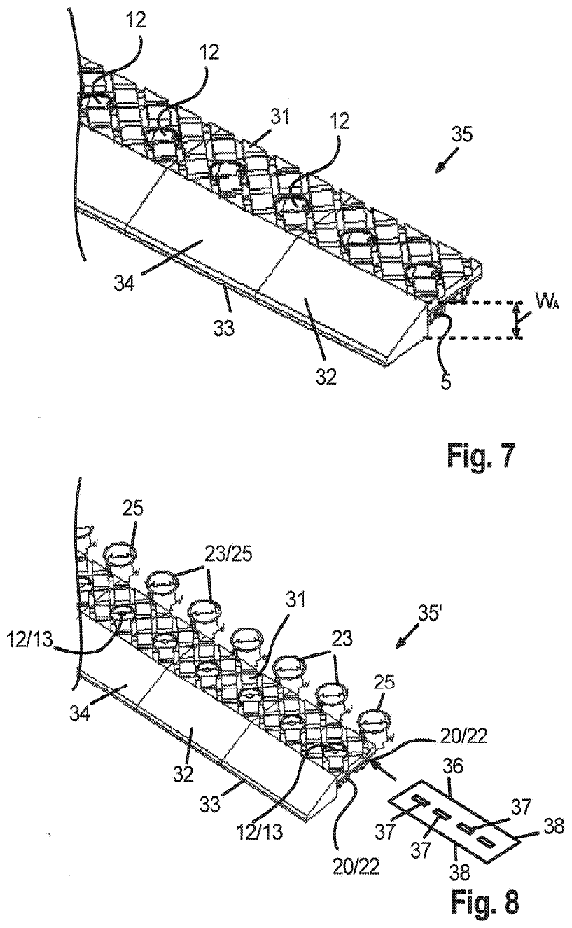

FIG. 7 a plan view of an end strip of the support,

FIG. 8 a plan view of an end strip with a molded connector,

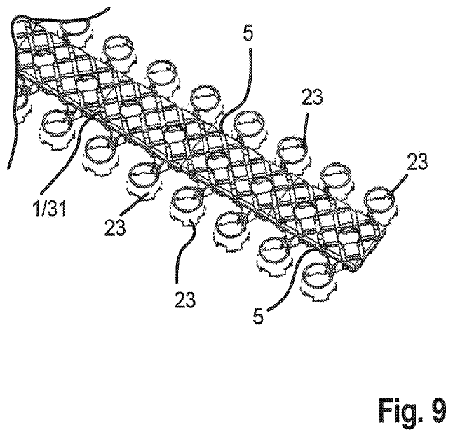

FIG. 9 a top view of a support with a connector formed on the edge,

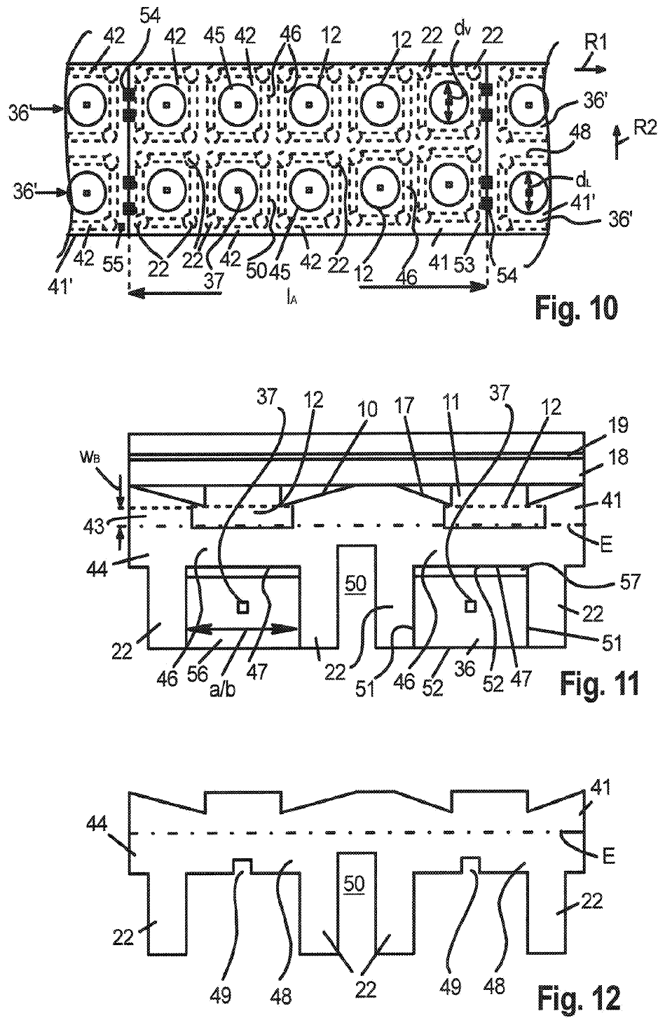

FIG. 10 a top view of a support on which light strips are arranged in rows on the underside with a plug-in connection at the edge,

FIG. 11 a partial cross section of the support according to FIG. 10 and

FIG. 12 a partial longitudinal section through the support of FIG. 10 without light strip.

A covering device according to the invention is used to cover gratings, which are not shown. Alternatively, the covering device can also be used as a floor covering outdoors and/or indoors, with the covering device preferably being laid on a solid floor material, for example tiles.

The covering device has a plurality of flat supports 1 which are each designed as support plates and which can be laid in a secure position on a floor 3 via a connector 2.

The support plates 1 are preferably of the same size. The support plates 1 are preferably rectangular, in the present exemplary embodiment square. They each have narrow edge sides 5 which converge in a corner area 4 of the support plate 1 and are straight.

The support plate 1 has a structured design, both on a top side 6 and on a bottom side 7 of the same. The support plate 1 has a first layer 8 made of a rigid material and a second layer 9 made of a flexible material. The first layer 8 is in the form of a carrier layer which rests on the floor 3 on the underside, for example. The second layer 9 serves as an absorption or wear layer which, in contrast to the carrier layer 8, comes into direct contact with bodies, environmental influences or the like. The second layer 9 thus forms an upper surface of the support plate 1.

The first layer 8 and the second layer 9 are connected to one another in one piece. For example, the two layers 8, 9 can be glued or welded. Alternatively, the two layers 8 and 9 can also be produced by two-component injection molding.

The upper side 6 of the supporting plate 1, which is essentially formed by the second layer 9, has a plurality of elevations 10 and depressions 11, which are arranged in a regularly distributed manner over the area enclosed by the narrow edge sides 5. The second layer 9 also has a number of perforations 12 which are distributed over the surface of the second layer 9. The perforations 12 in the second layer 9 are aligned with the perforations 13 in the first layer 8, so that liquid that hits the second layer 9, for example water, thawing snow or the like, can be drained off into the floor 3 below the support plate 1.

The perforations 12 of the second layer 9 are surrounded by the elevations 10 and the depressions 11, which are preferably distributed over the support plate 1 in the manner of a chess board.

The depressions 11 are designed as channels, via which the perforations 12 are connected to one another. In the present exemplary embodiment, the channels 11 run like a matrix or grid, with the channels 11 running tangentially to the perforations 12. As can be better seen from FIG. 4, the 4×4 perforations 12 arranged in a matrix-like manner are connected to one another by the channels 11 arranged in the shape of a cross. The perforations 12 are arranged relative to the channels 11 in such a way that a channel 11 meets the perforation 12 tangentially at a circumferential angle of 90° of the circular perforations. The channels 11 run diagonally according to FIG. 4 are thus essentially at a distance from adjacent channels 11 which corresponds to a diameter & of the perforations 12.

So that at least one elevation 10 is always arranged between the perforations 12, the perforations 12 are arranged offset to one another with respect to a direction running diagonal D. This means that perforations 12′ arranged in a diagonal row D₁ are offset to the adjacent diagonal row D₂ in the diagonal direction D, the offset in the diagonal direction D preferably being greater than the diameter of the perforations 12. Only the next to next row D₃ has exclusively transversely to the diagonal direction D offset to the perforations 12 of the diagonal row D₁ perforations 12″.

It can be seen that an elevation 10′, which is completely surrounded by the channels 11, is arranged between the perforations 12′ of the diagonal row D₁ and the perforations 12″ of the diagonal row D₃ The same applies accordingly to the other diagonal rows D₂ and D₄ as well D₃ and D₅.

The perforations 12 of adjacent diagonal rows D₁, D₂ are at least at a distance a from one another that is greater than a transverse extension b of the elevations 10. The adjacent perforations 12 are therefore at a distance from one another that is greater than a transverse extension b of the elevation 10.

To improve the drainage of the liquid in the direction of the perforations 12, the channels 11 are designed to be inclined with respect to a support plane E of the support plate 1. For this purpose, a channel base 14 of the channel 11 is formed inclined in the direction of the perforations 12′″ and 12^{IV}, starting from a point P1, which is arranged between two perforations 12 of the same diagonal D₅. Starting from the point P1, the channel thus has a channel depth that increases in the direction of the perforations 12′″ and 12^{IV}, while a channel wall 15 forms an edge of the elevations 10 on the top side. The upper edge of the channel wall 15 preferably runs parallel to the support plane E. Since the channels 11 in the vicinity of the respective perforations 12 are equipped with a channel depth that is increased in the direction of the perforations 12, the liquid can flow in the direction of the respective perforations 12 due to gravity flow. The perforations 12 thus each form locations in the support plate 1 at which the liquid is drained off via the channels 11, so that the channels 11 cannot form a reservoir for the liquid.

In addition, an upper side 16 of the elevations 10 can be configured as an inclined surface so that liquid impinging on the elevations is diverted to the adjacent channels 11. In the present exemplary embodiment, the upper side 16 of the elevations 10 is designed like a gable roof with two flat sloping surfaces 17. The sloping surfaces 17 are arranged at an acute angle of inclination y to the support plane E, as can be seen from FIG. 6. Alternatively, the sloping surfaces can also be convex, arcuate or mushroom-shaped if the elevations 11 are dome-shaped.

An underside 18 of the second layer 9 is flat in the same way as an upper side 19 of the first layer 8, so that the two layers 8 and 9 lie flat against one another.

Holding elements 20 are distributed on the underside 7 of the carrier layer 8 so that they can engage in openings in the grating for the detachable connection of the support 1 to the grating. As can be seen from FIG. 3, the holding elements 20 each have ring sections 21 on which four holding cams 22 are formed offset by 90° to one another in the circumferential direction of the ring section 21.

To lay the support plates 1 as a floor covering on the floor 3, connectors 23 are provided for the correct positioning of the support plates 1 with mutual contacting of edge sides 5 of adjacent support plates 1, which has a number of plug-in elements 25 each connected to one another via a coupling web 24. The plug-in elements 25 are designed in such a way that they can be inserted at least into the perforation 13 of the carrier layer 8 from below with a positive fit. The plug-in elements 25 are preferably designed to taper in the direction of the support plate 1, so that the assembly or placement of the support plate 1 on the respective connector 23 is simplified. In addition, the bond between the support plate 1 and the connector 23 is thereby improved.

The plug-in element 25 is ring-shaped and is held in the mounting position in a form-fitting manner in the perforation 13 of the carrier layer 8, specifically with outer annular surfaces 26 of the plug-in element 25 resting against corresponding walls of the perforation 13.

In the present exemplary embodiment, the connector 23 has four plug-in elements 25, so that four support plates 1 can be connected to one another. Alternatively, the connector 23 can also have only two plug-in elements 25, so that only two support plates 1 can be connected to one another. The greatest stability is achieved when the connector 23 has four plug-in elements 25. In this way, the support plates 1 are connected to one another in the correct position and with the respective positive connection with the connector 23 and are stable over the long term, with a single perforation 13 arranged in the corner region 4 being in engagement with the plug-in element 25.

As can be seen from FIG. 6, a free end of the retaining cams 22 forms the underside 7 of the support plate 1, which runs in a floor plane B together with an underside 27 of the connector 23. The support plates 1 can thus advantageously be laid in one plane while being coupled to the connectors 23.

The connector 23 is preferably made of a hard material.

The carrier layer 8 preferably consists of a recyclable material.

The support plate 1 and the connector 23 are preferably made of a plastic material or a composite plastic material.

According to a further embodiment of the invention according to FIG. 7, an elongated, preferably strip-shaped support 31 (support plate 31) is provided, which is positioned in an edge area of the surface to be laid as an edge finish. The support 31 essentially corresponds to the support 1 of the previous exemplary embodiment. In contrast to this, the support plate 31 is connected to a closing element 32 on an edge side 5 thereof. The closing element 32 is preferably formed onto the support plate 31. The closing element 32 tapers in the opposite direction to the edge side 5 of the support plate 31. A thickness WA of the closing element 32 on a side facing the edge side 5 of the support plate 31 corresponds to the thickness of the support plate 31. The thickness WA of the closing element 32 preferably decreases continuously in the direction of a closing edge 33 of the closing element 32, so that the covering device does not have any abutting edge. A risk of stumbling when walking on the covering device is thus counteracted. For example, an upper side of the closing element 32 forms an inclined surface 34 whose height WA decreases from the edge 5 of the support plate 31 to the closing edge 33. The inclined surface 34 can be flat or slightly curved. The closing element 32 is preferably connected to the support plate 31 in a materially bonded manner.

The support plate 31 together with the closing element 32 forms a closing strip 35 which is arranged on one or more edges of the covering device formed from the plurality of support plates 1. On one or more edge sides 5 of the support plate 31, which are not connected to the end element 32, further support plates 1, not shown, are connect, which are preferably detachably connected to the end strip 35 by means of the connector 23.

According to an alternative embodiment of an end strip 35′ according to FIG. 8, in comparison to the end strip 35, this can additionally have a connector 23 connected in one piece to the support plate 31 on an edge side 5 of the support plate 31 facing away from the end element 32. The connector 23 has a plurality of plug-in elements 25 arranged in a row, which can be positively connected by plugging them into corresponding perforations 12/13 in one or more support plates 1. The plug-in elements 25 are preferably bonded to the support plate 31. They can be produced together with the support plate 31 and the end element 32 by injection molding.

According to an alternative embodiment of the invention, a light strip 36 with a plurality of light sources 37 can be arranged on an underside of the support plate 31. The light strip 36 preferably has a carrier plate or a printed circuit board, on which a plurality of light sources 37 designed as LED light sources are arranged. The elongate carrier plate 36 can, for example, be inserted in a form-fitting manner between two rows of holding elements 20 of the support plate 31, with the holding cams 22 of the holding elements 20 preferably pressing against a longitudinal side 38 of the strip-shaped carrier 36. The strip 36 is thus held in a form-fitting manner on the underside of the support plate 31. Since the light sources 37 are arranged on a flat side of the strip 36 facing the upper side of the support plate 31, the light emitted by the light sources 37 can pass through the perforations 12/13 and thus illuminate the end strip 35. Even if the covering device is not provided with the closing element 32 at the edge, undesired tripping when walking on the covering device can thereby be prevented. The carrier 36 preferably has a length that corresponds to the length of the edge side 5.

According to a further embodiment of the invention according to FIG. 9, a plurality of connectors 23 can be formed on the support 1, 31 on at least one edge side 5 thereof. As a result, in contrast to the embodiment according to FIGS. 1 to 6, loosely arranged connectors 23 can advantageously be dispensed with. The support plates 1 and possibly the edge-side support plates 31 thus have integrated connectors 23 so that the support plates 1 and 31 can be connected to one another without the additional assembly step of plugging the connector 23 onto the edge sides 5 of the support plates 1 and 31. The covering device composed of the plurality of support plates 1, 31 is advantageously given greater strength and stability.

According to an alternative not shown embodiment, the support plate 1 or 31 can be colored, for example colored in the form of an arrow symbol, so that when the support plate 1, 31 is located accordingly, a user is shown the way on the covering device. The support plate 1 or 31 is dimensioned so large that a desired symbol or inscription can be produced by coloring. The coloring can be red or green, for example, with the base color of the support plate 1, 31 being a gray or light gray color.

A support 41 shown in FIG. 10 is made in one piece from a single recyclable plastic material. For example, the support 41 can be made of a TPE material by one-component injection molding.

The support 41 is elongate and has a plurality of support segments 42 which are arranged in a chessboard and/or matrix-like manner and extend in the support plane E. In the present exemplary embodiment, the support segments 42 are of identical design.

The support segments 42 have a square basic shape. Alternatively, they can also be rectangular or have a shape.

The support segments 42 each have in a center the single perforation 12 with the diameter d L. A plurality of holding elements or holding cams 22 are preferably provided at the edge of the perforation 12. In the present exemplary embodiment, the holding cams 22 are each arranged in corner regions of the support segments 42. The arrangement of the perforations 12 and the retaining cams 22 of the support 41 thus correspond to the corresponding perforations 12 and retaining cams 22 of the previous exemplary embodiments.

In accordance with the previous exemplary embodiments, the support 41 has a base body 43 which extends continuously over the support plane E of the support 41 and has the perforations 12. Extending from the base body 43 in the area of each support segment 42 is a reinforcement section 44, from which the retaining cams 22 protrude in the corner area. The reinforcement section 44 is arranged circumferentially to the perforation 12 and has for each support segment 42 a recess 45 covering the perforation 12, which at least partially has a greater extent than the perforation 12. In the present exemplary embodiment, the recess 45 is arranged in a circle with a diameter which is larger than the diameter d_{L} of the perforation 12. In this way, a gap is always formed for the liquid to flow through the perforation 12 in the direction of the bottom side.

The reinforcement section 44 assigned to each of the support segments 42 has a first connecting strut 46 which forms a contact surface 47 for the light strip 36 to rest on the same. Furthermore, the reinforcement section 44 has a second connecting strut 48 which runs perpendicularly to the first connecting plane 46 and connects pairs of retaining cams 22 connected via the first connecting strut 46. The first connecting strut 46 and the second connecting strut 48 each extend in the support plane E. The second connecting strut 48 has a drainage groove 49, so that a predetermined drainage path from an upper side of the support 41 via the perforation 12 to a drainage channel 50 arranged between the support segments 42 is guaranteed. In contrast to this, the previous exemplary embodiments also have a drainage groove on the first connecting strut 46, so that the liquid can drain both directly into the drainage channels 50 running in the first direction R1 and into the drainage channels 50 running perpendicular to the same, second direction R2.

The retaining cams 22 are flexible. A clear distance a between two retaining cams 22 connected via the first connecting strut 46 essentially corresponds to a width b of the light strip 36, so that the light strip 36 can be positively and/or non-positively held resting on the contact surface 47 of the first connecting strut 46 between the two retaining cams 22.

In the present exemplary embodiment, the light strip 36 has a rectangular cross section and has flat longitudinal edges 51 and parallel flat sides 52 connecting the same. End faces 53 of the light strips 36 have a plug-in connection 54 so that a number of light strips 36 assigned to one support 41 can be electrically contacted with light strips 36′ connected to adjacent supports 41′. In addition, the light sources 37 of the light strips 36 arranged next to one another on the long side are electrically connected to one another, so that all light sources 37 of the light strips 36 assigned to the respective supports 41 can be controlled individually by means of a control unit 55 arranged in the edge region of the support 41. In this way, graphic patterns and/or an inscription and/or a logo can be produced in the same and/or different colors.

The light strip 36 has a length that corresponds to a length l_{A} of the support 41.

The light strip 36 has a base material 46 which can be translucent and/or opaque. On a cover side facing the perforation 12 there is a cover layer 57 made of a transparent material. The light source 37 is located within the base material 16 or is essentially enclosed by the base material 16.

As can be seen from FIG. 10, a diameter dv of the reinforcement section 44 (preferably circular inner surface surrounding the perforation 12) is greater than a diameter & of the perforation 12. This ensures that liquid can drain through the perforation 12 the discharge channel 50 can take place. A depth of the perforation 12 corresponds to a wall thickness w_{B} of the base body 43.

In the present embodiment, the retaining cams 22 are cylindrical. A diameter of the retaining cams 22 is smaller than a diameter of the perforations 12.

The light strip 36 can be made of a flexible, translucent or translucent plastic material. The retaining cams 22 have greater flexibility than the light strip 36.

The retaining cams 22 are arranged in pairs in the first direction of extent R1 and in the second direction of extent R2, which runs perpendicular to the first direction of extent R1. There are several rows of pairs of retaining cams, between which the light strip 36 is arranged and fixed in an assembly position. The first direction of extent R1 and the second direction of extent R2 each run in the support plane E.

As in the aforementioned exemplary embodiments, the upper side of the support 41 has the elevations 10 and depressions 11, the elevations 10 each having the inclined surfaces 17 and the depressions 11 each having, at least partially, an inclined channel bottom 14.

In addition, a glass plate 18 made for example of a composite material can be arranged on an upper side of the support 41. If the transparent glass plate 18 has a mirrored surface 19 which is designed to be partially translucent, the covering device can have a mirror appearance when the light sources 37 are switched off, while producing an illumination pattern when the light sources 37 are switched on. The glass plate 18 can preferably cover several supports 41. The glass plate 18 can preferably cover multiple tiers. The glass plate 18 is, for example, connected to the supports 41 in a form-fitting and/or force-fitting or material-fitting manner.

The supports 41, 41′ can have dimensions of approx. 850 mm×200 mm and can cover six light strips 36. 156 light sources 37 are thus integrated in a single support 41, 41′, if it is assumed that the light sources 37 are distributed uniformly over the light strip 36 and/or the support 41, 41′. In the present exemplary embodiment, the number of light sources 37 per square meter of support 41 is approximately 936. To increase the resolution, the number of light sources 37 can be increased, if necessary by reducing the diameter of the perforations 12, so that the number of light sources 37 per square meter is increased to 1000 to 2000 per square meter. As a result, the resolution of the generated light pixels, which shine through the respective perforations 12, can be increased in such a way that films or videos can be displayed. In particular, when a number of pads 41 are used to cover house facades, the covering device can be used to play videos for informational or advertising purposes. The number of light sources 37 and/or perforations 12 per square meter can be in a range between 500 and 2000, for example.

The plug-in connection 54 is preferably designed to be waterproof.

Alternatively, the covering device can also be used to cover facades. The cover is preferably used to cover floors, outdoors and indoors, for example also steps.

The light sources 37 are preferably in the form of semiconductor-based light sources, in particular LEDs.

The supports 41, 41′ shown in FIGS. 10 to 12 are preferably laid on a floor without connectors 23. Alternatively, they can also be connected to one another via the connector 23.

1. A covering device for gratings with a flat support (1) having an underside (7) and an upper side (6) and with a plurality of holding elements (20) protruding from the underside (7) of the support (1), wherein on the upper side (6) of the support (1) a plurality of elevations (10) and depressions (11) are provided.

2. The covering device according to claim 1, wherein the support (1) has a plurality of perforations (12, 13) which are each connected to a number of elevations (10) and depressions (11).

3. The covering device according to claim 1, wherein the elevations (10) and the depressions (11) are distributed over the support (1), at least one of the elevations (10) and the depressions (11) being arranged inclined relative to a support plane (E) and wherein the depressions (11) are channels that connect the perforations (12) with each other.

4. The covering device according to claim 1, wherein the elevations (10) each have inclined surfaces (17) and/or the channels (11) each have a channel base (14) which, starting from a point (P1) remote from one of the perforations (12, 12′″, 12^{IV}) runs inclined in the direction of the perforation (12).

5. The covering device according to claim 1, wherein the support (1) has a first layer (8) made of a rigid material and, on an upper side (19) thereof, a second layer (9) made of a flexible material, wherein the first layer (8) and the second layer (9) have aligned perforations (12, 13) and the second layer (9) has the elevations (10) and the depressions (11).

6. The covering device according to claim 1, wherein the support (41) consists of a flexible material and/or is one piece.

7. The covering device according to claim 1, wherein the support (1) is a rectangular support plate with narrow edge sides (5) which run between corner areas (4) of the support plate (1), and wherein a holding element (20) arranged in the corner area (4) can be detachably connected to a plug-in element (25) of a connector (23) in a form-fitting manner, so that adjacent support plates (1) can be arranged in a correct position relative to one another in a common plane (E, B).

8. The covering device according to claim 1, wherein the holding elements (20) have a number of holding cams (22) which surround respective perforations (12, 13) with a free end face, which respectively run along a common floor plane (B).

9. The covering device according to claim 1, wherein an end element (32) adjoins one edge side of the support (31) to form an end strip (35) which tapers in the direction of a closing edge (33) of the closing element (32) facing away from the edge side (5) of the support plate (31).

10. The covering device according to claim 1, wherein a light strip (36) is arranged on an underside of the support (1, 31) with light sources (37) of the light strip (36) overlapping perforations (12, 13) of the support (1, 31), so that light from the light strip (36) can pass through the perforations (12, 13) to illuminate at least a partial area of the support (1, 31).

11. The covering device according to claim 1, wherein the support (1, 41) has a plurality of support segments (42) arranged in a chessboard-like and/or matrix-like manner, which extend in the support plane (E) and in each case in the middle have perforation (12) and at the edge have holding elements (22).

12. The covering device according to claim 11, wherein the support (1, 41) has a base body (43) extending in the support plane (E) with reinforcement sections (44) assigned to each of the support segments (42) and arranged on an underside of the support (1, 41) and containing a contact surface (47) for the light bar (36), and that the holding elements (22) protrude transversely to the support plane (E) from the reinforcement section (44).

13. The covering device according to claim 12, wherein the contact surface (47) is formed by a first connecting strut (46) which runs tangentially to the perforation (12).

14. The covering device according to claim 12, wherein the first connecting strut (46) extends between two holding elements (22) arranged in a corner region of the support segment (42) and wherein a second connecting strut (48), which runs perpendicular to the first connecting strut (46), has a drainage groove (49).

15. The covering device according to claim 10, wherein the holding elements (22) are flexible and wherein a clear distance (a) between two holding elements (22) of the respective storage segments (42) corresponds to a width of the light strip (36), so that the light strip (36) is held between two holding elements (22) in a form-fitting and/or non-positive manner with the same resting on the contact surface (47).

16. The covering device according to claim 12, wherein the reinforcement section (44) has a recess (45) covering the perforation (12), wherein the extent (R1, R2) is greater than an extension of the perforation (12) running in the same direction.

17. The covering device according to claim 10, wherein the light strip (36) is elongate, with longitudinal edges (51) of the light strip (36) being clamped in by the holding elements (22) arranged in pairs of a row of storage segments (42) and wherein a flat side of the light strip (36) arranged on the side facing away from the perforation (12) runs flush with the free end face of the holding element (22).

18. The covering device according to claim 10, wherein a length of the light strip (36) corresponds to a length (1A) of the support (1, 41) and wherein end faces (53) of the light strip (36) are mechanically and electrically connected to a further light bar (36′) of an adjacent support (41′) via a plug connection (14).

19. The covering device according to claim 10, wherein the light sources of the light strip (36, 36′) can be controlled individually in order to generate a graphic pattern, an inscription and/or a logo

20. The covering device according to claim 1, wherein a glass plate (18) having a mirrored surface (19) is applied to an upper side of the shelf (41).
